(19) United States
(12) Patent Application Publication
(10) Pub. No.: US 2017/0116880 A1
(43) Pub. Date: Apr. 27, 2017

(54) Integrated and interactive multi-modal framework for speech therapy

(71) Applicant: Geetha Srikantan, Palo Alto, CA (US)

(72) Inventor: Geetha Srikantan, Palo Alto, CA (US)

(21) Appl. No.: 15/330,651

(22) Filed: Oct. 24, 2016

Related U.S. Application Data
(60) Provisional application No. 62/285,260, filed on Oct. 23, 2015.

(51) Int. Cl. G09B 19/04; G09B 5/06

(52) U.S. Cl. CPC G09B 19/04; G09B 5/065

(57) ABSTRACT

The present invention relates to a speech therapy and audio learning. Specifically, this invention relates a multi-media and multi-modal framework for interactive speech therapy and audio learning using handheld devices, such as smartphones, tablets, and laptop and desktop computers.

This invention is that of an Integrated Multi-Modal Interactive Framework for Speech Therapy

This invention provides a framework in which lessons are prepared and recorded by the expert for the Learner to practice by interacting via multi-modal interfaces, and also recorded for review by the expert and the learner.

Further, this invention provides the platform on which learning sessions are created with differing levels of multi-modal interaction, complexity and game-playing, to engage and enhance the learning experience.

### RELATED WORK

1. Provisional Patent Application Number 62/285,260

### BACKGROUND OF THE INVENTION

Speech impairments or loss due to paralysis/stroke or injury affects thousands of individuals each year, often times with loss of mobility due to the injury or stroke. For such individuals, in-person learning sessions with a speech or audio therapist/expert are not as frequent as needed, due to physical/mobility constraints, limited medical coverage, and cost constraints. It is very important for such individuals to receive expert guidance during their recovery and to practice exercises given by the experts. Today, there are very limited means by which the expert/therapist can monitor progress of their learners, between visits.

In a paralytic stroke the degree of damage in the brain determines the impact on sensory and neural pathways. Speech and audio therapy is used to recover speech, along with physical therapy to recover limb movements. Existing systems for speech therapy are quite rigid, non-adaptive and expensive. One recent application, iSwallow is available for Apple iPhones to assist in speech therapy, is a positive development for this space.

However, these existing applications are not interactive in multi-modal format. Existing applications are not integrated with the entire therapy/learning cycle. There is no learning platform where multiple Lessons and practice sessions are recorded for later review and evaluation.

### BRIEF SUMMARY OF THE INVENTION

This invention is that of an Integrated Multi-Modal Interactive Framework for Speech Therapy

This invention provides a framework in which lessons are prepared and recorded by the expert for the Learner to practice by interacting via multi-modal interfaces, and also recorded for review by the expert and the learner.

Further, this invention provides the platform on which learning sessions are created with differing levels of multi-modal interaction, complexity and game-playing, to engage and enhance the learning experience. The role of the expert/therapist remains paramount, hence this invention is intended to provide a framework to assist the expert (speech therapist).

In the present invention multi-modal interfaces with simple and intuitive visual cues to assist in learning audio/speech, and tactile or mouse/pointer interfaces provide mechanisms for Learners to interact while practicing lessons. As the individual progresses, game-playing exercises of increasing complexity are constructed with short fragments of audio, to engage the Learner and provide additional feedback. To overcome limitations of individual devices, this framework provides integration with a common repository and compute environment, such as a public cloud or private cloud, and software to transfer recorded lessons and practice sessions between devices and the cloud. Transfer of such information is using well-known technologies such as HTTP, TCP which are widely used and supported.

This invention also has application for non-speech-impaired individuals for learning a new language or improving proficiency in a foreign language, as well as for language assistance while traveling in a foreign land.

### BRIEF DESCRIPTION OF THE DRAWINGS

The drawings enclosed within this document are described briefly in relation to the text.

FIG. 1. The Guide vocalizes short fragment of speech or audio (for example, a word-fragment or entire word), the Learner vocalizes the same short fragment of speech. These audio inputs are converted to visual form. The visual form is shown on a screen of a device such as a handheld or mobile phone or computer.

FIG. 2. The Learner manipulates the visual form of her/his audio fragment via tactile or pointer interface (such as the touch screen or keyboard). Audio associated with the modified audio is rendered via Speaker. Visual output associated with the modification is also shown in comparison with the Guides.

FIG. 3. The audio fragments and visual forms shown in FIG. 1, are recorded via a Record interface. These recordings are stored on the flash memory or hard disk storage available on handheld devices such as smartphones, tablets or computers. Recording over the network to a remote device is another option. Sharing via live network stream is another option.

FIG. 4. The audio fragments and visual forms shown in FIG. 2, are recorded by a Record interface. These recordings are stored on the flash memory or hard disk storage available on handheld devices such as smartphones, tablets or computers. Recording over the network to a remote device is another option. Sharing via live network stream is another option.

FIG. 5. The audio and visual fragments recorded are replayed via Replay interface. These fragments are replayed from the storage medium either locally on the device or computer, or from the remote device over the network.

FIG. 6. Presents a workflow of usage of the framework and platform of this invention. It indicates a sequence of operations by the Guide and Learner, during the course of Lesson preparation, practice sessions, visual rendering, storage, retrieval and related operations.

### DETAILED DESCRIPTION OF THE INVENTION

The following description is presented to enable any person skilled in the art to make and use the invention, and is provided in the context of particular applications of the invention and their individual requirements. Various modifications to the disclosed embodiments will be readily apparent to those skilled in the art and the general principles described herein may be applied to other embodiments and applications without departing from the spirit and scope of the present invention. Thus, the present invention is not intended to be limited to the embodiments shown, but to be accorded the widest scope consistent with the principles and properties disclosed herein.

This invention describes an interactive multi-modal framework to assist in speech and audio therapy with mechanisms for rendering visually, tactile manipulation of recording, feedback and game-playing.

In the following description, Guide refers to the Expert or Therapist or Teacher, and Learner refers to the Student or Patient.

The enviroment of the framework includes:
1. audio recording device such as a microphone (on smartphone, tablet or computer);
2. graphical/visual rendering device such as a screen (on smartphone, tablet or computer);
3. tactile interface such as the touch screen of smartphones, tablets and computers;
4. mouse or key-based interaction such as on smartphones, tablets and computers
5. storage device such as the flash memory or hard disk of smartphones, tablets, computers
6. network connectivity for upload/download as provided by carrier for smartphone, tablets, computers
7. public cloud and private cloud resources for storage and computation

The framework includes:
1. mechanisms to capture audio input from Guide and Learner, which is then converted and rendered in a visual form;
2. mechanism to use tactile controls to alter sound and appearance; mechanisms to render audio and visual feedback for Learner to compare and learn from;
3. mechanisms to record the audio and visual fragments via Record interface;
4. mechanisms for the Learner and Guide to replay the audio and visual fragments via Replay interface.

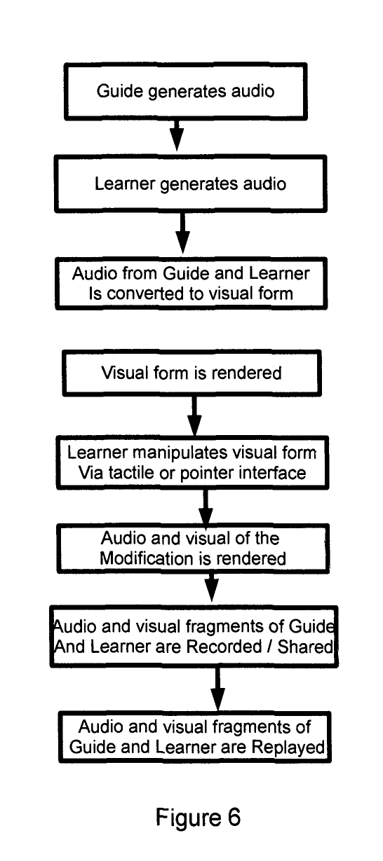

### Typical Workflow (FIG. 6)

A typical workflow for speech therapy using this framework is described below to illustrate how the each mechanism in the framework works in conjunction with other mechanisms.
The Learner and Guide meet in person to review practice sessions and for in-person speech therapy.
Guide records audio, plays back, edits and saves it into a Lesson. The Lesson is made available to Learner by uploading into a common repository accessible to both Guide and Learner.
Learner accesses Lesson and plays back each portion of the Lesson, practices orally to reproduce the sound of the Guide's audio. Learner records practice session, views a visual rendering of practice session, and saves the session. The practice session is uploaded to the same or other common repository for access by Learner or Guide.
Guide accesses practice sessions and evaluates aurally as well as the visual rendering of practice session segments with respect to Guide's audio segments. Guide annotates the practice session with notes and further instructions.
A slightly advanced learner examines the visual renderings of their own recording and the Guide's to compare where the differences are.
A slightly more advanced Learner, manipulates the visual rendering of practice session audio using either a tactile (touch) interface or mouse/trackpad and plays back the modified rendering. By this the Learner is able to identify audio variations. Learner has a choice to practice using the modified segment and save it as part of, the session.

The Guide examines how LEarner has adjusted the audio fragment and compares with Guide's own audio, to infer how the Learner has evolved in this practice session. Guide annotates these sessions as well.

The Learner and Guide meet in person to review practice sessions and for in-person speech therapy.

The Learner and Guide review lessons and practice sessions from recent and past, either together or each at their own convenience.

For the more advanced Learner, the Guide prepares Lessons with greater complexity—using longer speech segments, to represent words, and sentences. Guide prepares simple games using the framework to construct them.

Lessons and practice sessions are archived for safe-keeping and evaluations that span multiple months.

For a distant Learner, a live internet-streaming session is used by the Guide and Learner, in lieu of a face-to-face in-person session.

### Detailed Mechanisms of this Invention

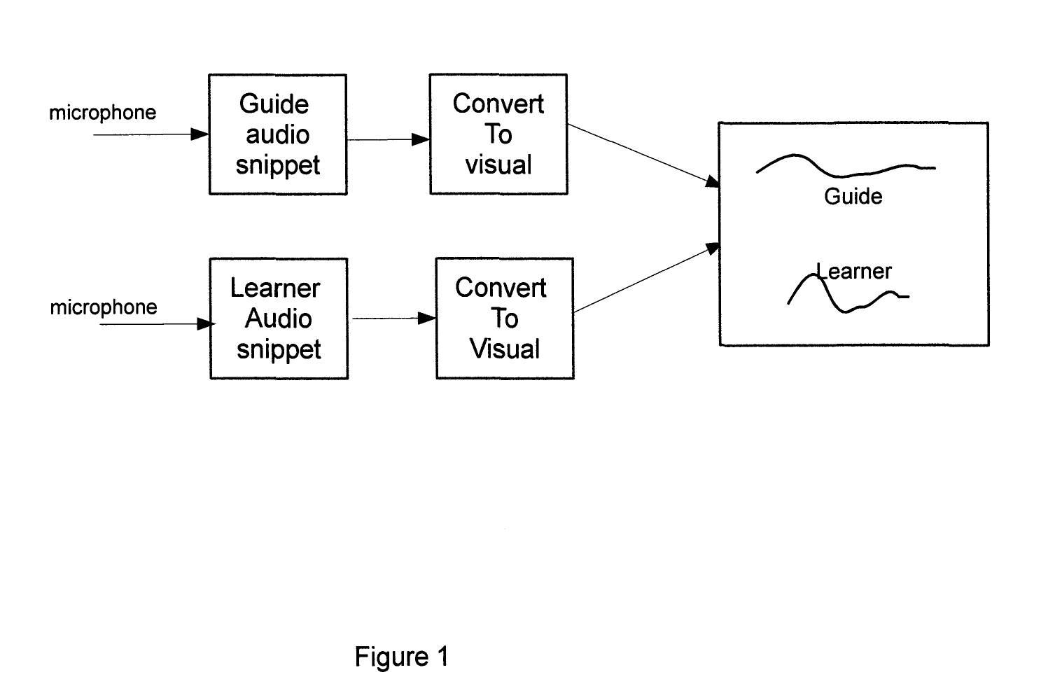

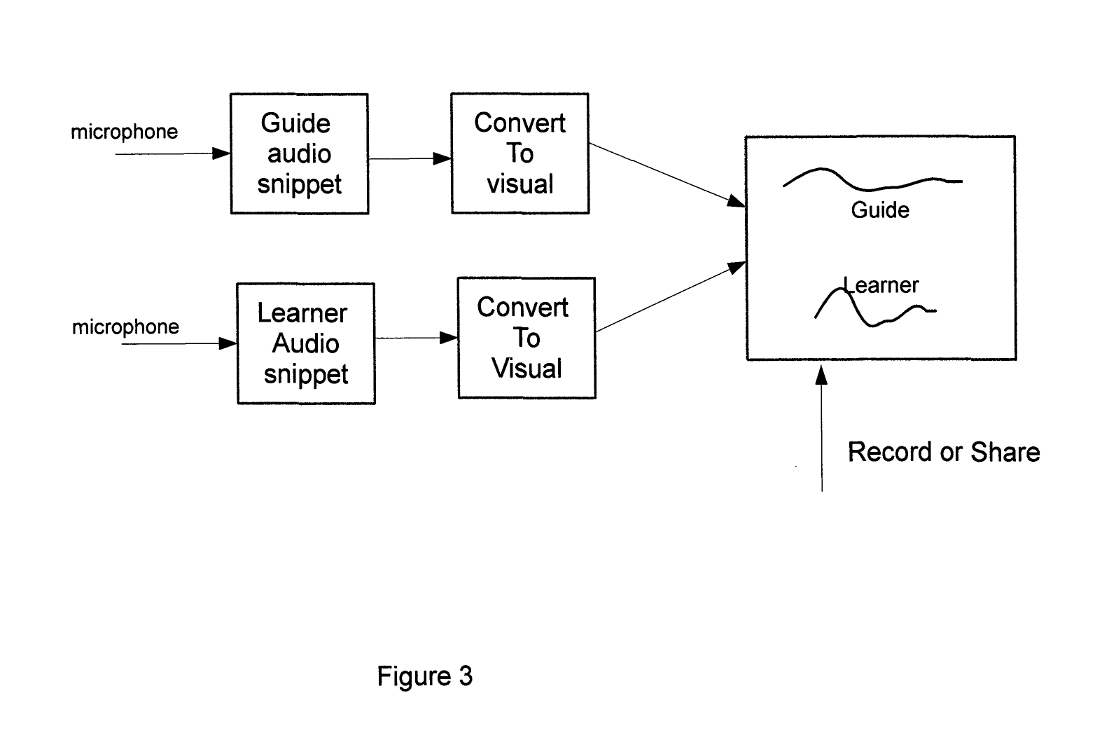

1. Capture and record audio segments as individual lessons. FIG. 1 and FIG. 3 illustrate an interface for the Guide to record audio segments using a Microphone to create a customized individual lesson. In one embodiment of this user interface, the user is presented with choices to record, playback, edit and save the recording into a lesson plan. This interface is customized to adapt to the dimensions and capabilities of a smartphone, tablet, laptop and desktop computer. Software to access microphone when needed and record in digital format such as MPEG2, MPEG4 etc.

2. Mechanism for Learner to vocalize audio in attempt to match Guide's audio, and then record it alongside Guide's audio. FIG. 1 and FIG. 3 illustrate an aspect of the system which includes software to access microphone when needed and record in digital format such as MPEG2, MPEG4 etc is integrated within the framework.

3. Collecting practice sessions of audio and converting to visual rendering for Speech or Audio Guide to review. FIG. 1 and FIG. 3 illustrate an embodiment in which the recorded audio segments (from Guide and Learner) are processed using software to extract features from the audio segment and presented in abstracted visual form (graph, similar intuitive representation) such that the visual renderings are distinguishable for different audio recordings.

4. Mechanisms for the Learner to manipulate the visual form to generate associated audio; This is intended as a feedback mechanism to assist the Learner with distinguishing related sounds;

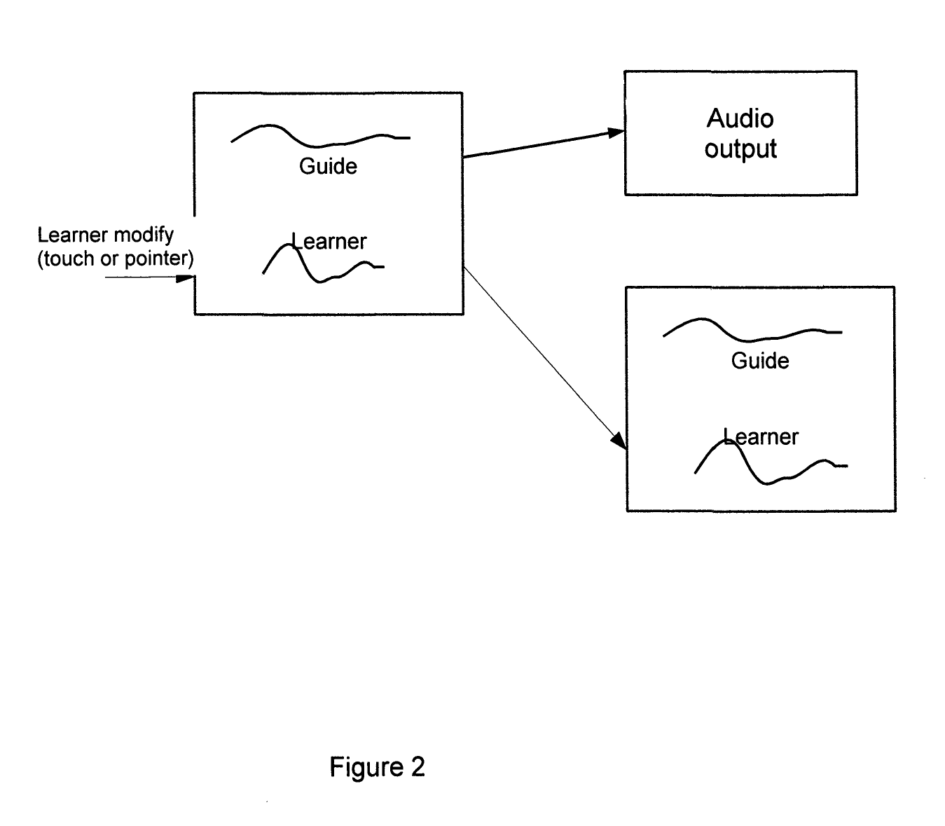

FIG. 2 illustrates an embodiment in which the Learner uses tactile interface, mouse or track pad interface to manipulate visual form and then generate the associated audio. Software to capture tactile input in relation to a visual representation and transformation of the visual rendering based on tactile inputs is part of the framework. Software to convert the modified visual representation into audio using a speech synthesizer is also part of the framework.

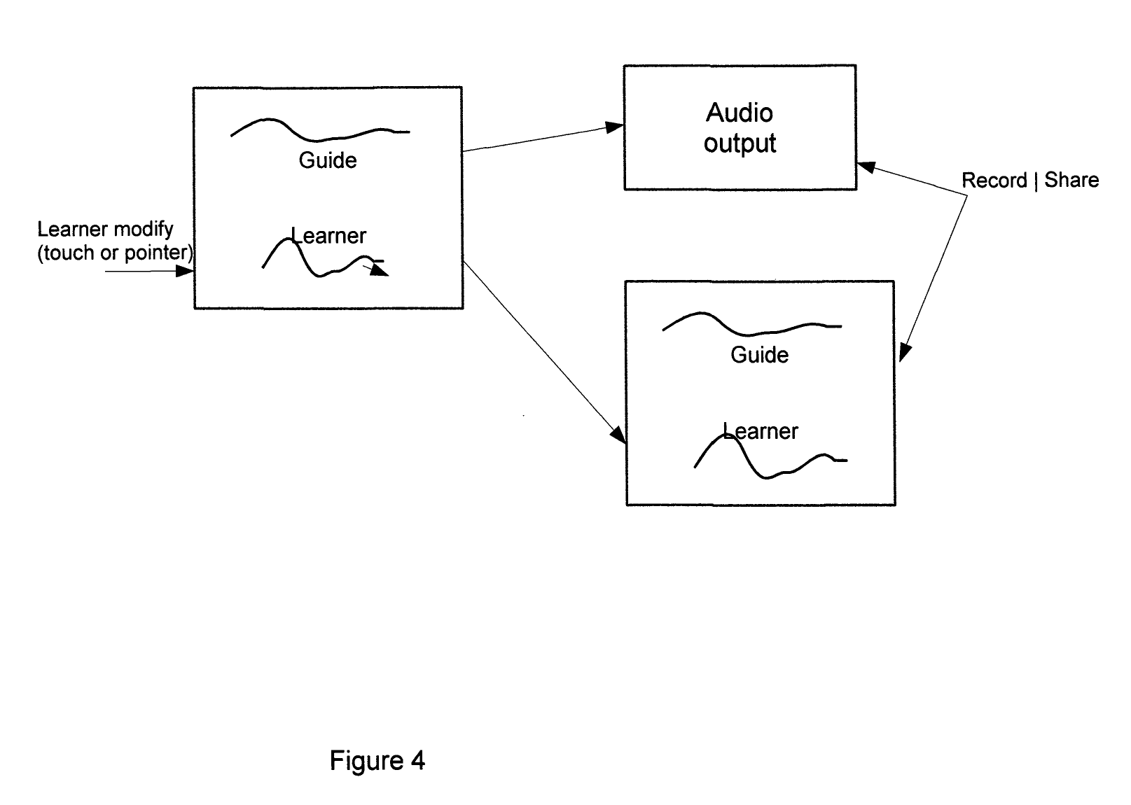

5. Mechanism for the Learner to record manipulated audio and visuals; FIG. 4 illustrates an embodiment to record manipulated visual rendering and associated audio, based on the original recording. Software to process these different recordings for comparison and present an interpretation of this comparison, is part of the framework.

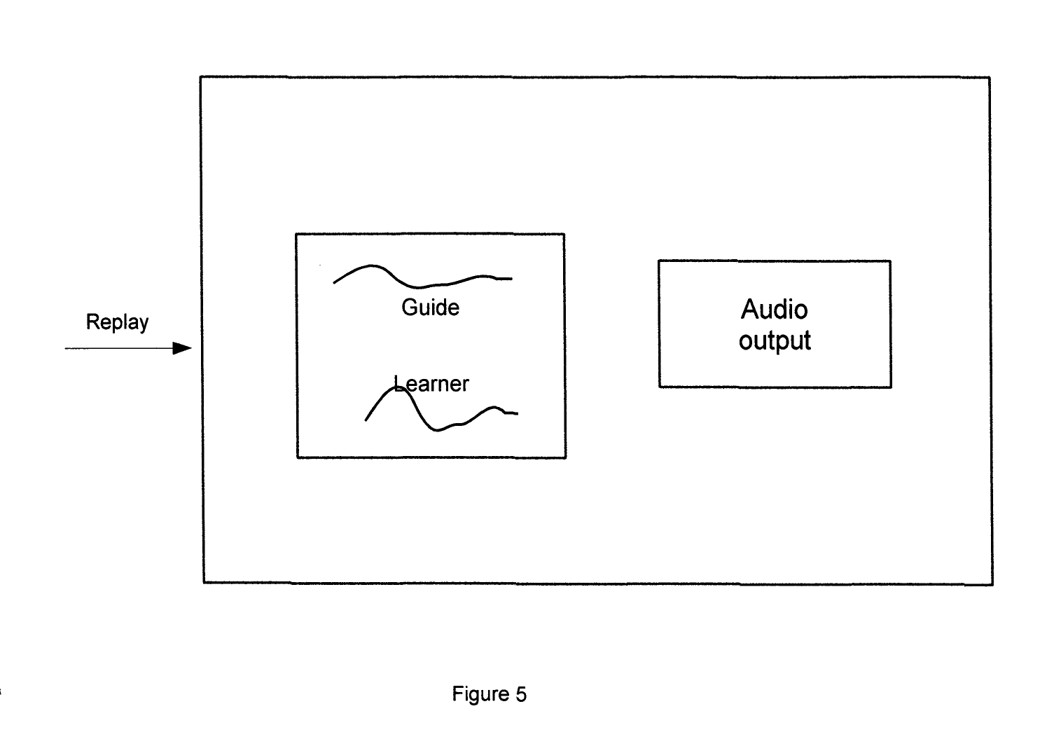

6. Mechanism for each of these to be replayed. FIG. 5 illustrates an embodiment in which any of the recordings—lesson or practice session can be played back, including the visual rendering. Software to support selection of the recording and playback. Recordings are replayed by Learner for the benefit of learning to hear and vocalize distinctions. Recordings are replayed by the Guide to evaluate series of audio/visual recordings of Learner and provide further guidance via newer audio or other means.

7. Mechanism to group recorded speech fragments and visuals by criteria such as Lesson number, Date/Time, Practice session count, and so on. In one embodiment of this framework, an online filing system is presented to assist in storage and retrieval of Lessons and practice sessions, by Date, patient and other criteria.

8. Mechanism to share via upload/download over the computer network for non-immediate feedback from Guide; In one embodiment of this mechanism an upload interface is presented to the user to save recording or session into a common repository, and to retrieve chosen items from the common repository. The common repository is made available via this framework using a public or private cloud.

9. Mechanism to share via live streaming over a computer network, for immediate feedback from Guide; In one embodiment of this mechanism an internet link between the Learner and Guide is established to conduct an in-person session without requiring them to co-located.

10. Mechanism for retain sequence of Lessons, Practice sessions for ongoing reviews to track progress over time. Typically the learner would practice such a sequence of sessions; the Guide would evaluate Learner's progress in the recorded sessions and provide further instructions to refine or repeat some of the sessions.

11. Augmented lesson and session storage and retrieval based on cloud-based technologies.

12. Augmented compute resources to process recordings for feature extraction, manipulation, rendering and adaptation, based on computational resources of a private or public cloud. In one embodiment of this framework, additional compute resources are made available to offload the processing from the handheld device or computer, such that processing of recordings for feature extraction, manipulation, rendering, adaptation is done using compute resources from a public or private cloud.

1. An Integrated and Interactive Multi-Modal Framework for Speech and Audio learning which integrates mechanisms to create audio lessons, record or save such lessons, replay saved lessons, stream audio lessons, tactile & pointing-device based mechanisms to replay Lesson and practice and record the practice, render visual abstraction of audio, manipulate the visual rendering and transform into synthesized audio.

2. The method of claim 1, further comprising software and hardware based mechanisms for Guide to record lessons, upload lessons.

3. The method of claim 1, further comprising mechanisms for rendering audio from Lessons for the Learner, records audio from the practice session.

4. The method of claim 1, further comprising a mechanism to transform the practice audio into a visual rendering.

5. The method of claim 1, further comprising a mechanism to manipulate the visual rendering using a touch screen or mouse or trackpad type of pointing device.

6. The method of claim 1, further comprising a mechanism to render synthesized audio from the manipulated visual rendering.

7. The method of claim 1, further comprising a mechanism to record the entire practice session, including visual rendering, manipulation and generated audio.

8. The method of claim 1, further comprising mechanisms for the Guide to playback practice sessions for evaluation.

9. The method of claim 1, further comprising mechanisms for the Guide to annotate and store lessons.

10. The method of claim 1, further comprising software and hardware mechanisms for Guide to construct more advanced lessons and games for Learner.

11. The method of claim 1, further comprising provides software, hardware and cloud technologies for remote access of lesson and practice sessions.

12. The method of claim 1, further comprising provides software, hardware and cloud technologies for storage, retrievalof lesson and practice sessions.

13. The method of claim 1, further comprising provides software, hardware and cloud technologies for live streaming of lesson and practice sessions.

14. The method of claim 1, further comprising provides software, hardware and cloud technologies for distribution, of lesson and practice sessions.

15. The method of claim 1, further comprising provides software, hardware and cloud technologies to offload the processing of audio signals to generate visual rendering such that individual handheld devices and computers can access such capability in a dynamic way.

16. The method of claim 1, further comprising provides software, hardware and cloud technologies to offload the processing of visual rendering to generate synthesized audio, such that individual handheld devices and computers can access such capability in a dynamic way.
